(19) United States
(12) Patent Application Publication
(10) Pub. No.: US 2026/0301409 A1
(43) Pub. Date: Oct. 1, 2026

(54) PRODUCT TAMPERING REDUCTION AND PREVENTION SYSTEM

(71) Applicant: TOSHIBA GLOBAL COMMERCE SOLUTIONS, INC., Durham, NC (US)

(72) Inventors: Kristen CHUNG, Durham, NC (US); Kirk Alexander GOLDMAN, Durham, NC (US); Theodore CLARK, Durham, NC (US); Manda MILLER, Durham, NC (US); Sam CHAMPAGNE, Durham, NC (US); Pranit KOTGIRE, Durham, NC (US); Levent KACAN, Durham, NC (US)

(73) Assignee: TOSHIBA GLOBAL COMMERCE SOLUTIONS, INC., Durham, NC (US)

(21) Appl. No.: 19/095,443

(22) Filed: Mar. 31, 2025

(51) Int. Cl. G06V 20/52; G06V 10/74

(52) U.S. Cl. CPC G06V 20/52; G06V 10/74

(57) ABSTRACT

Systems and methods for providing store intelligence. The methods involve: receiving, from at least one camera, imaging data of a person tampering with an object for sale in a shopping area of a store; determining, using the imaging data taken by the camera(s), that a tampering event is occurring or has occurred before the object has been presented to be purchased; flagging the object as a tampered object so that remediating steps can be taken to prevent the tampered object from being sold.

### BACKGROUND

Tampering with items in retail stores is an issue that retail stores want to prevent. For example, product altering or switching is a form of retail shrink where shoppers improperly tamper with SKUs in the store. This might come in the form of changing the items in a multi-pack, switching out clothing in a set, or switching lids on items like water bottles fraudulently. The result is an item that no longer matches its original manufacturer description/image and is therefore not sellable. Moreover, altered products cause shopper frustration because they are sometimes unable to buy the intended item or they return the product upon discovery that item is not as manufacturer intended. Currently, there is no way to detect that products are altered other than employee visual inspection at the shelf or at the point of sale.

### BRIEF DESCRIPTION OF THE DRAWINGS

The objects and features of the present disclosure can be better understood with reference to the drawings described below, and the claims. The drawings are not necessarily to scale, emphasis instead generally being placed upon illustrating the principles of embodiments of the present disclosure. In the drawings, like numerals are used to indicate like parts throughout the various views.

FIG. 1 illustrates a diagram of components in a store with a shopping area and a checkout area where the store employs the tampering detection system in accordance with some embodiments.

FIG. 2 illustrates block diagram of an exemplary architecture for a camera shown in FIG. 1. in accordance with some embodiments.

FIG. 3 illustrates an integrated shopping environment, according to one embodiment.

FIG. 4 illustrates block diagram of an exemplary architecture for the tampering detection system shown in FIG. 1 in accordance with some embodiments.

FIG. 5 illustrates a flow diagram of an exemplary method for providing store intelligence for a tampering detection system in accordance with some embodiments.

FIGS. 6A-6C illustrate determining field of view information for a person and identifying items included within a determined field of view, according to one embodiment.

FIGS. 7A and 7B illustrate views of several exemplary predefined behavior types, according to one embodiment.

### DETAILED DESCRIPTION OF THE EMBODIMENTS

Generally, the present disclosure provides a system and method for sending alerts to a point-of-sale system (“POS”) for highly tampered items, using camera vision to compare items at POS to ecommerce image to ensure items are not tampered with. This can be done using cameras in-aisle that can detect activities that are indicators of product tampering including but not limited to repeated lifting and replacing of products on shelf, visual changes to color and count of items touched by a shopper upon shelf replacement. camera feeds. Moreover, models may be employed that learn the behavior that precedes tampering, and the present disclosure contemplates using that learning to determining that tampering has occurred (or is about to occur), at which time: the product can be identified and flagged as a high-risk tamper item, a flag is sent to the POS system that item is a high risk item, store personnel can be alerted, and/or the like.

At checkout at the POS, if a shopper scans a flagged high-risk tamper item, triggering the high-risk tamper item alert, the POS device can determine whether the item is as expected. For example, computer vision at the self-checkout or item recognition at the fixed lane point of sale compares image to e-Commerce image to ensure item does not have any customer driven modifications. If the comparison model determines the product has not been switched or tampered with, the transaction is allowed to complete; otherwise, if the product comparison model determines the product (or a portion thereof) has been switched or tampered with, then an alert is sent to the associate for intervention.

It is undesirable that a product be checked out where the item has been tampered with because: the item price may not be the same, buying the wrong item will create inventory errors, an unsuspecting future buyer may buy the wrong item or a part of the item may be missing or not correct for that item, etc.

Various examples and more details of the present disclosure will now be described below. The following description provides specific details for a thorough understanding and enabling description of these examples. One skilled in the art will understand, however, that the present disclosure may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the present disclosure. Certain terms may even be emphasized below; however, any terminology intended to be interpreted in any restricted manner will be overtly and specifically defined as such in this Detailed Description section.

With reference now to the figures, the present disclosure provides a novel intelligence system for various applications, such as retail applications. The intelligence system employs a camera network, a computing system etc. that communicate over a network to determine/prevent someone from checking out with a tampered product.

In this present disclosure, camera outputs are received in order to determine if an article has been or is being tampered with. For example, the camera outputs are used to detect: when a portion of or on the article (e.g., an SKU on the article, a portion of the article, etc.) is being handled in a tampering manner; when the movements/actions of the customer indicates that the customer has likely tampered with the article thereby indicating that the product/user should be monitored in the near future until the product tampering is corrected or until the product is attempted to be checked out.

The manner in which such detections are made is described in more depth below. Upon one or more of the above-listed detections certain measures may be taken. For example, if it is determined that the retail item is in the possession of a user, then the POS can be notified to verify the item at checkout and/or the requisite store personnel can be informed and/or dispatched to remedy the product tampering. Notably, the present disclosure provides a predictive and preventative type of tamper detection technique for business organizations selling, renting, or loaning items to the general public (e.g., retail stores or libraries).

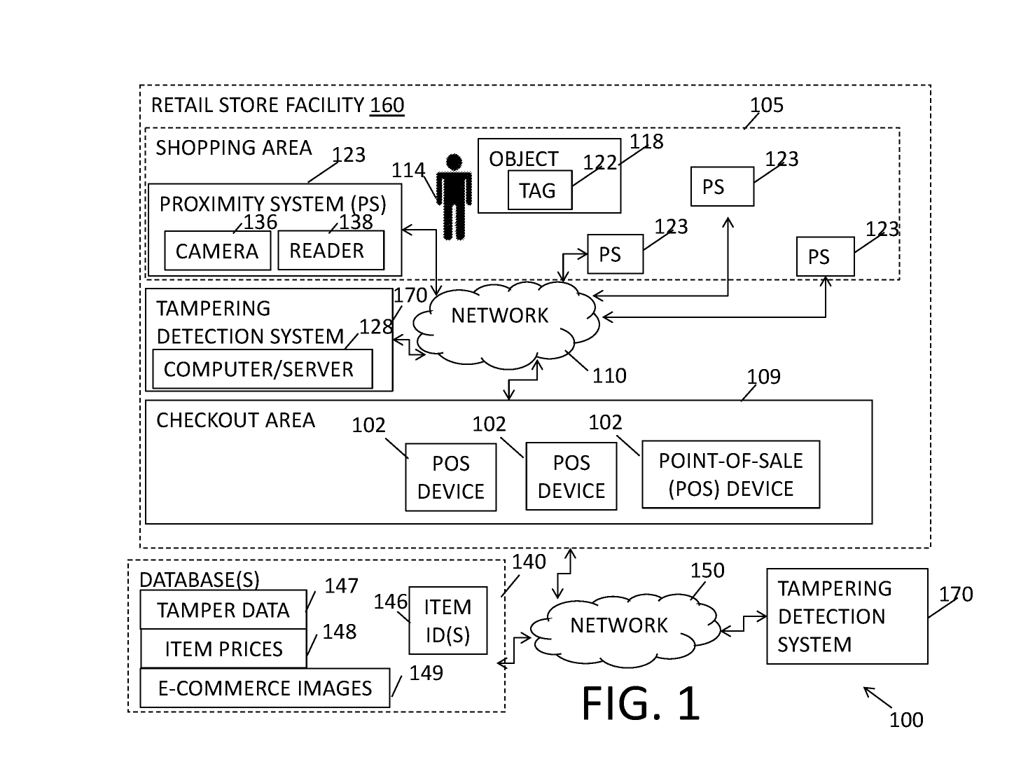

Referring now to FIG. 1, there is provided a schematic illustration of an exemplary system 100. The system 100 is generally configured to allow improved retail store intelligence for tampering detection prior to a user reaching a checkout area 109 and while the user is attempting to check out at the checkout area 109 with the tampered product using imaging technology and processing.

As shown in FIG. 1, system 100 comprises one or more database(s) 140, a retail store facility (“retail store”, “store” or “RSF”) 160, and/or a tampering detection system 170 which are communicatively coupled to each other via a network (e.g., the Internet) 150.

The retail store 160 includes a shopping environment 105 and a checkout area 109 as well as a tampering detection system 170 and optionally a local area network 110 of the store.

The shopping environment 105 is the area of the store where the articles or objects (e.g., food, electronics, clothing, etc.) 118 are being displayed for sale. For example, the articles or objects may be placed on shelves of isles, on racks, or the like in the shopping environment 105. As shown in FIG. 1, the shopping environment 105 is separate from the checkout area 109 and is not where the person 114 can checkout or potentially buy some items. In this regard, FIG. 1 is an illustration showing the physical layout of the store with the shopping environment 105 being separated from the checkout area 109 by a predetermined distance (e.g., 10 feet, 50 feet, 100 feet, etc.).

The checkout area 109 of the store 160 includes one or more kiosks, such as point-of-sale (“POS”) devices 102, configured to allow the user to buy any of the objects 118 for sale in the store. This checkout area 109 is typically next to the store exit but is not required to be.

The database 140 includes various data items that the POS devices 102 in the checkout area 109 can query including item IDs 146, prices 148 of each item, e-commerce images 149 of products, or any other data for use in the systems 170 and POS 102. The database 140 may also include tampering data 147 such as tampering movement/actions indicative of tampering for use with the tampering detection system 140 as is discussed herein. These items 146, 147, 148, etc. in the database 140 can be created and updated regularly via a central computer system.

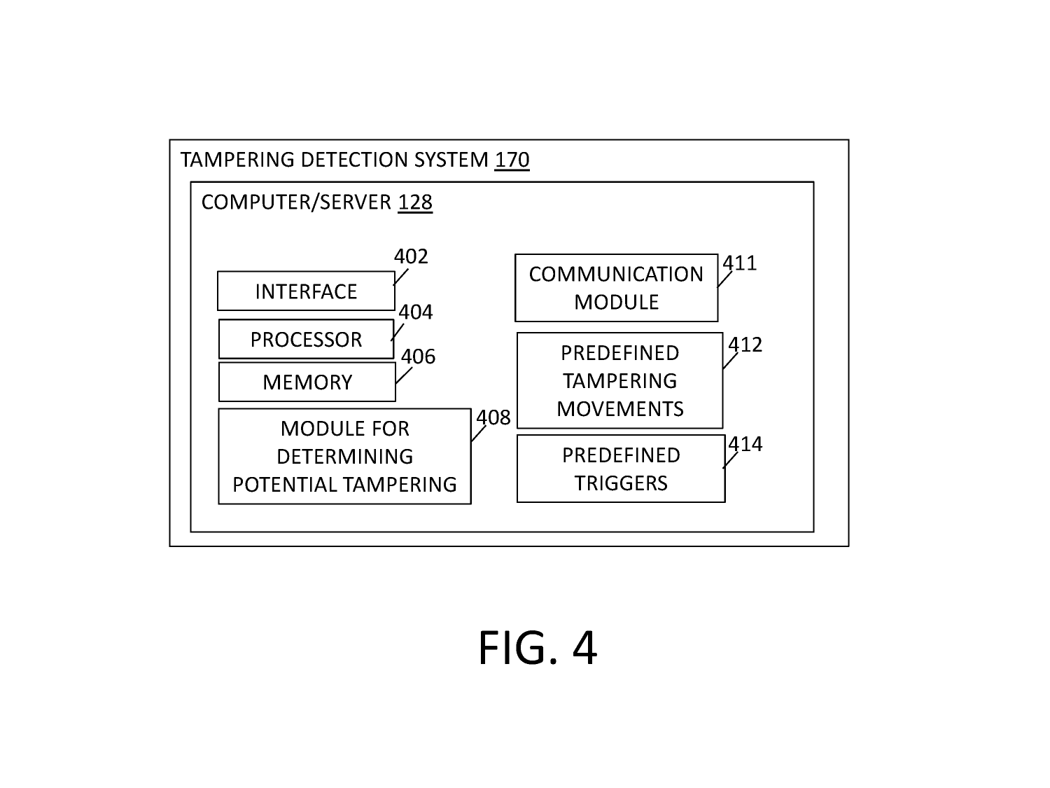

The tampering detection system 170 is a system for collecting data (image data), analyzing the data (image data, data in database 140, etc.) and determining whether a potential tampering event is occurring or has occurred. The tampering detection system 170 includes a computer/server 128 which is configured to perform the operations disclosed herein. The computer/server 128 is discussed in more depth with regard to FIG. 4.

Although FIG. 1 is shown as having the tampering detection system 170 internal to the retail store facility 160 and external to the retail store facility 160, the present disclosure is not limited in this regard. For example, the tampering detection system 170 can reside in a different building or geographic area than the store 160 and thus, does not need to be on the same network 110 as the store. Alternatively, the tampering detection system 170 can be the same part of the retail store facility and/or be on the same network as the store’s network 110. In some embodiments, the tampering detection system 170 can be the same part of the retail store facility 160 and also remote from the retail store facility 160 via network 150.

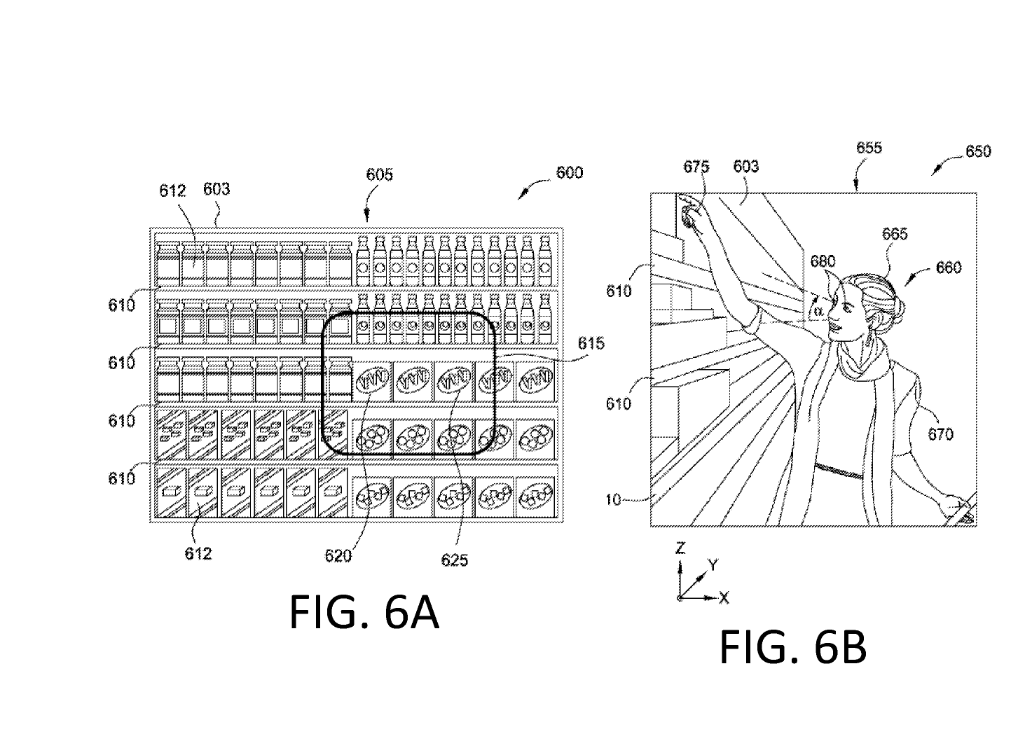

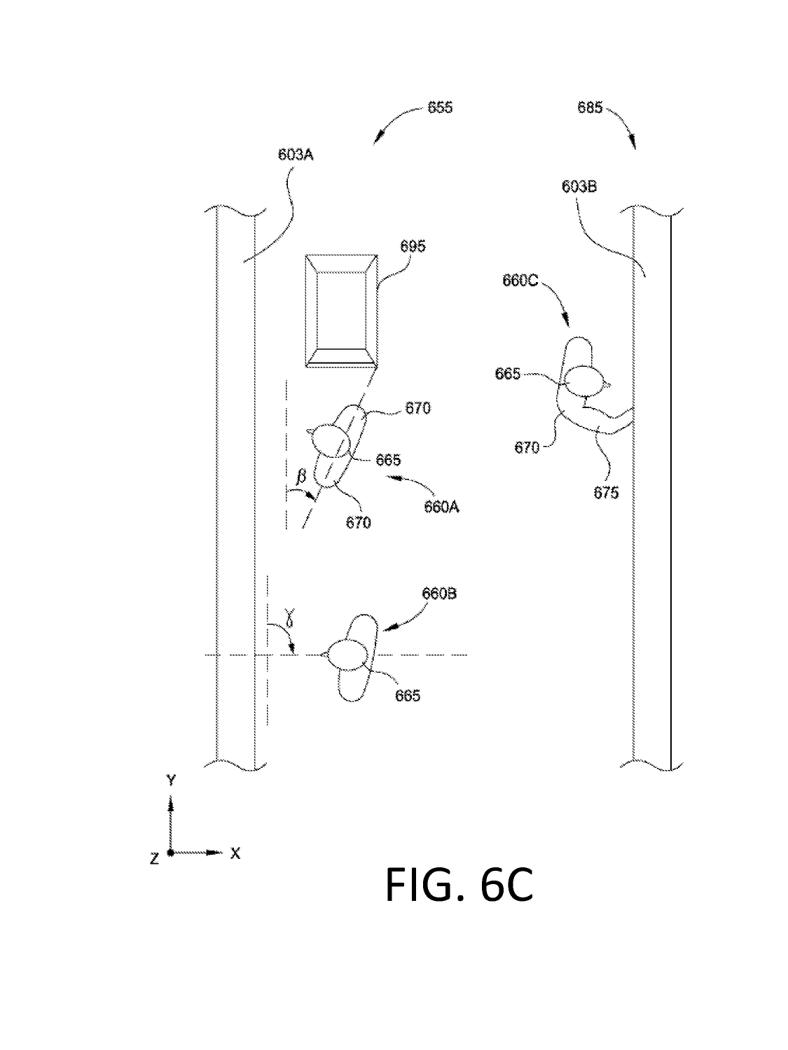

The store 160 is generally configured to provide enhanced store security, store intelligence and customer service. In this regard, the store 160 comprises a network 110 defined by a plurality of proximity systems (“PS”) 123 disposed at various strategic locations therein. For example, a first proximity system 123 is coupled to an isle, shelves, floor space, positions above the isles/shelves, etc. in the shopping area 105 where articles or objects for sale are located. A second proximity system 106 is disposed on or in another area that is remote from the checkout area 109. In one embodiment, a third proximity system 123 and additional proximity systems are located in other areas where products are displayed for sale. There may be proximity systems in areas other than the shopping area 105 as well such as in a fitting room (not shown), at the store exit, high-risk locations within the store 160 (e.g., a bathroom) and any other area where there is no coverage from any other PS 123. In this regard, all areas of the RSF 160 may be covered by the PS systems 123. More information about the PS systems (cameras) are discussed in more depth later herein with regard to FIG. 6.

Each proximity system 123 comprises a camera 132 (and optionally other systems such as an RFID reader 138). The camera 132 is used to real-time monitor of actions of those shopping in the store 160 to assist in determining the movement of people in the RSF 160. The camera 132 can determine if a potential tampering event is happening based on predefined movements and historical machine learning events. Certain events are examples of tampering movements/actions: picking up an item and placing it back down multiple times, a user looking around after picking up or studying an item for sale, a person holding/manipulating a product in their hands for more than a predetermined time period, a person seen scraping, manipulating, pulling, disassembling the item, removing product packaging/seals, concealing the product in the person’s personal belongings (e.g., purse, bag, clothing, etc.), and any other event that is other than a person searching for, selecting an item, and immediately placing the item in the person’s shopping cart/basket. For example, the camera 132 may detect that a user has removed a lid of a water bottle. The same may perform analytic based operations to determine if one of the above tampering events has occurred.

To use the analytic based operations, the camera 132 sends a real-time imaging feed/videos, images, etc., and the imaging data is sent to the tampering detection system 170 via communication components. At the tampering detection system 170, the imaging data is used for analytic based operations, as briefly mentioned above. The analytic based operations are performed in accordance with pre-defined tampering events, predefined tampering actions/movements, and/or business rules stored in the tampering detection system 170.

The present disclosure is not limited to cameras as devices for obtaining information relating to the movement of people in and around the store. Accordingly, any other imaging system may be used.

The reader 138 is generally operative to communicate information to and/or from the security tags 122 coupled to objects/articles 118 (e.g., merchandise) and/or other communication devices via short range technology (e.g., Bluetooth, RF technology, etc.) in case a tampered item is moved within the store. The other communication devices can include, but are not limited to one or more computer/server devices 128 within the tampering detection system 170 of the store 160, and the like. The computing device/server 128 may act as the tampering detection system (also referred to herein as a store intelligence system (“SIS”)).

In some scenarios, the reader 130 may be an RFID reader which outputs a constant beacon within a predetermined area around the reader. It should be understood that the reader 130 can be used as a transmit device and/or as a receive device using RF technology. The information communicated from the reader 130 to the tampering detection system 170 can include, but is not limited to, a unique identifier of the tag 122 as well as the unique identifier of the reader 130. The unique identifier of the reader 130 provides a means to determine the location of an item within the store 160 using a security tag 122. The tag-related information can be used to track movement of a tampered item within the store 160, determine if the security tag of a tampered item has been deactivated and/or detached from an article 118, and inform store personnel of the results of various analytic based operations. The store personnel can be informed in real time or at user-specified times via a communication device (e.g., a mobile phone or handheld equipment) over the network 110.

Abnormal movement can be detected based on the above-identified movements of the user but also the movement of the item (e.g., a relatively fast downward movement of the item may indicate a motion to remove or dissemble the item, such as slamming the security tag on a hard surface), a pattern of the item movement over a given period of time, etc. Pre-stored threshold values and/or image data patterns can be employed in comparison operations to distinguish between normal movements and abnormal tampering movements.

Although the tampering detection system 170 is shown in FIG. 1 as residing in both the store 160 and remote from the store 160 over network 150, the tampering detection system 170 does not need to be remote from the store 160 in all situations. For example, if the store 160 is part of a relatively small store chain, then the tampering detection system 170 might be located in one of the retail stores. The tampering detection system 170 could also be a cloud function as well. In this case, the tampering detection system 170 might be located in a server rented from a cloud provider.

In view of the forgoing, various operations are performed at the tampering detection system 170 using imaging data prior to the person 114 getting to the checkout area 109. For example, the imaging data is used to (1) increase the security of products of the store 160 to prevent a person 114 attempting product tampering, (2) track a user through the retail store when the user has tampered an item, (3) flag and track a product that has been tampered with, and/or (4) collect, store, analyze, and use information regarding behavioral patterns of those who tamper with store items.

When an item is determined to have been tampered with, the tampering detection system 170 will identify the tampered item and flag the item. This may be a specific item or if the item cannot be specifically determined, all items in the category could be flagged. For example, if a user is tampering with a water bottle, but the specific water bottle that was tampered with cannot be determined, the system will identify all water bottles of that brand to be flagged until the tampered item is found, and the tampering has been remedied. This is so that the user does not check out with a tampered item to avoid theft, a lowered price, etc. and also so unsuspecting customers that do not know about the tampering to not buy the tampered product.

Accordingly, if a user tampers with a product and the tampering detection system 170 determines that the user is carrying the tampered product in his cart or with him in some other manner in an intent to check out with the tampered product, the system will flag the item so that the tampering detection system 170 will not allow the user to purchase the tampered item at the POS 102.

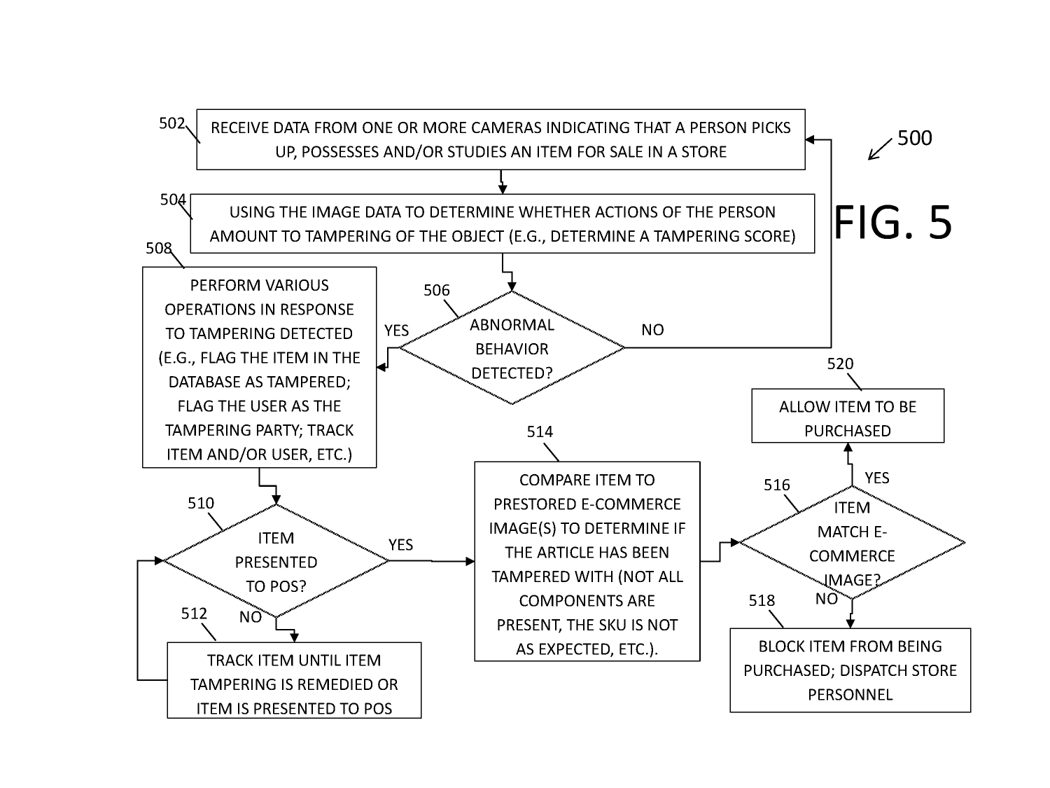

Indeed, during store hours, a customer 114 may desire to purchase the article 118 and to do so, the customer 114 scans the article 118 via a fixed POS station 102 (e.g., a checkout counter) or a mobile POS station (e.g., the customer’s mobile device). However, once the article 118 has been successfully scanned, the POS 102 determines whether the item has been flagged by comparing an identifier of the scanned item with the database 140. If the tagged item has not been flagged in the database 140, the POS 102 allows the user to purchase the item. However, if the POS 102 determines that the item has been flagged, the POS 102 then compares an image of the item with an e-Commerce image 149 of the item stored in the database 140 to determine the integrity of the product. If this comparison shows a confidence level greater than a predefined threshold that the product matches the e-Commerce image 149, the user may be allowed to purchase the item because it is as expected. However, if this comparison shows a confidence level less than the predefined threshold, the POS 102 alerts store personnel and/or the user that the item cannot be purchased because it is likely a tampered item. More on this process is discussed later herein with respect to FIG. 5.

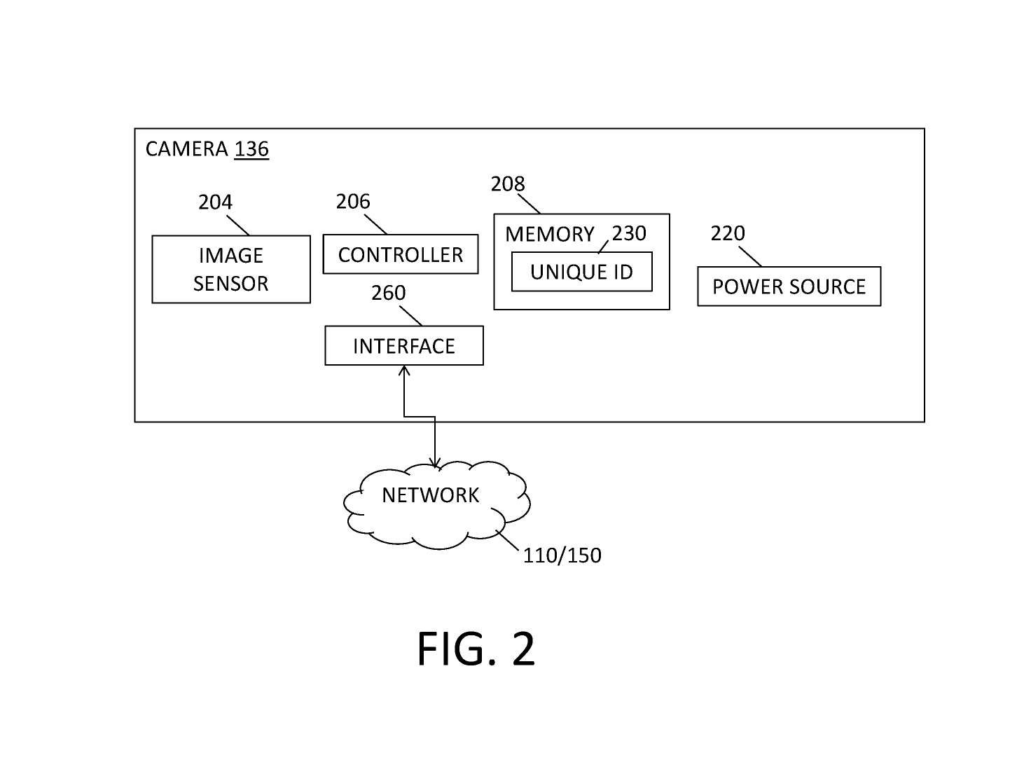

The hardware architecture of FIG. 2 represents an embodiment of a representative camera 136 configured to facilitate improved store intelligence, store security, and data analytics. In this regard, the camera 136 is configured to capture images and/or video for processing by the tampering detection system 170. The camera 136 may include components 204, 206, 208, 260 and a power source 220 shown in FIG. 2 but may include less or additional components.

The camera 136 includes an image sensor 204 for capturing images/video using imaging technology. The images/video may be transmitted along with a unique identifier 230 of the camera 136. The unique identifier 230 provides a means for the tampering detection system 170 to determine the location of a person located within a given facility (e.g., RSF 160 of FIG. 1) because it is associated with the location of the camera 136.

At the controller 206, the information may be pre-processed to determine how the signal is to be handled by the camera 136. For example, certain tampering movements/actions may be detected by the camera 136 itself to alert the tampering detection system 170 and only such detected movements may be transmitted to the tampering detection system 170, in some embodiments.

The memory 208 may be a volatile memory and/or a non-volatile memory. For example, the memory 208 can include, but is not limited to, a RAM, a DRAM, a ROM and a flash memory. The memory 208 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure.

Data collected by the camera 136 may then be passed to the tampering detection system 170 via interface 260 which transmits data to/from the network 110.

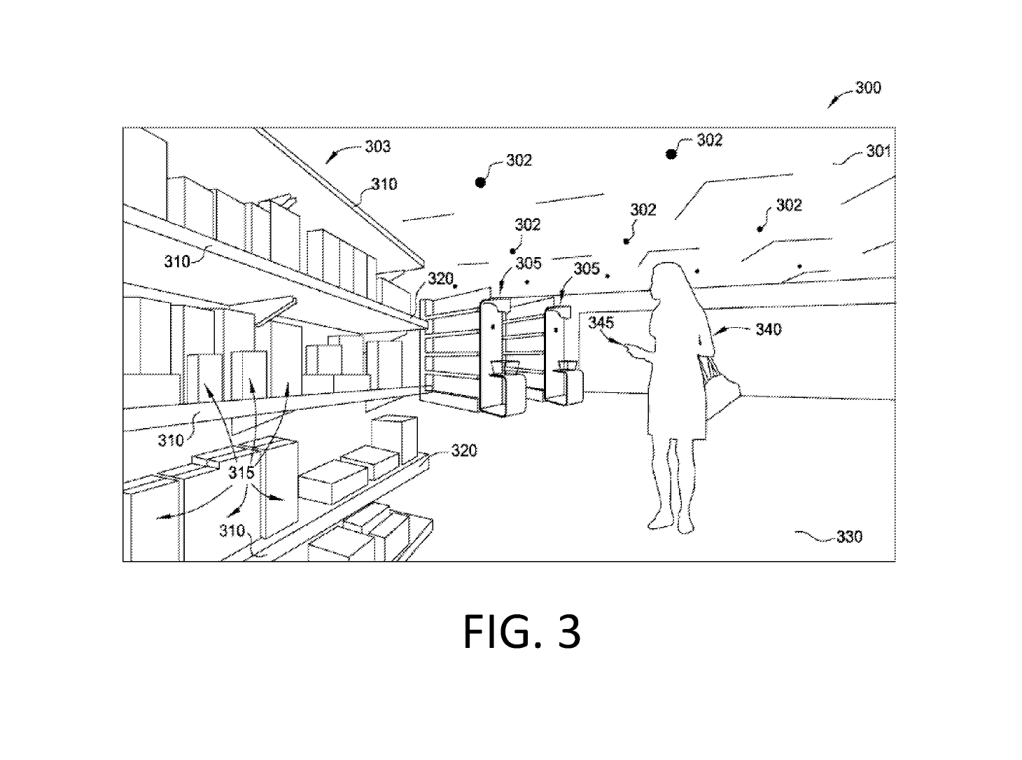

Referring now to FIG. 3, FIG. 3 illustrates an integrated shopping environment 300 is provided which includes a plurality of sensor modules 302 disposed in the ceiling 301 of the store. Each sensor module 302 may include one or more types of sensors, such as cameras, audio sensors (e.g., microphones), and so forth. Sensor modules 302 may also include actuating devices for providing a desired sensor orientation. Sensor modules or individual sensors may generally be disposed at any suitable location within the environment 300. Some non-limiting examples of alternative locations include below, within, or above the floor 330, within other structural components of the environment 300 such as a shelving unit 303 or walls, and so forth. In some embodiments, the sensors (cameras) may be disposed on, within, or near product display areas such as shelving unit 303. The sensors (cameras) may also be oriented toward an expected location of a customer interaction with items, to provide better data about a customer's interaction, such as determining a customer's field of view.

The shopping environment 300 also includes a number of kiosks 305, which may be a POS 102. Generally, kiosks 305 allow customers to purchase items or perform other shopping-related tasks. Each kiosk 305 may include computing devices or portions of computing systems, and may include various I/O devices, such as visual displays, audio speakers, cameras, microphones, etc. for interacting with the customer. In some embodiments, a customer 340 may have a mobile computing device, such as a smartphone 345, that communicates with the kiosk 305 to complete a purchase transaction. In one embodiment, the mobile computing device may execute a store application that is connected to the networked computing systems (e.g., through servers), or may be directly connected to kiosk 305 through wireless networks accessible within the environment (e.g., over Wi-Fi or Bluetooth). In one embodiment, the mobile computing device may communicate with the kiosk 305 when brought within range, e.g., using Bluetooth or NFC.

Environment 300 also includes shelving units 303 with shelves 310 and items 315 that are available for selection, purchase, etc. Multiple shelving units 303 may be disposed in a particular arrangement in the environment 300 to form aisles through which customers may navigate. In some embodiments, the shelving unit 303 may include attached and/or embedded visual sensors or other sensor devices or I/O devices. The sensors or devices may communicate with a customer's smartphone 345 or other networked computing devices within the environment 300. For example, the front portions 320 of shelves 310 may include video sensors oriented outward from the shelving unit 303 to capture customer interactions with items 315 on the shelving unit 305, and the data from the video sensors may be provided to back-end servers for storage and/or analysis. In some embodiments, portions of the shelving unit 303 (such as the front portions 320 of shelves 310) may include indicator lights or other visual display devices or audio output devices that are used to communicate with a customer.

Referring now to FIG. 4, an exemplary tampering detection system 170 is shown. The tampering detection system 170 includes the computer/server 128. The computer/server 128 may include an interface 402, processor 404, memory 406, a module for determining potential tampering (“tampering determination module”) 408, a communication module 411, predefined tampering movements 412, and predefined triggers 414.

The processor 404 is configured to execute computer readable instructions stored in memory 406 to perform one or more method steps discussed in FIG. 5. For example, the processor 404 is configured to read and execute instructions from memory 406 for the tampering determination module 158. Each of the steps discussed herein may be programmed for the tampering detection system 170 to perform the specific steps recited herein.

The communication module 411 and the tampering determination module 408 software programs stored in memory in the computer/server 128 or may be stored over a network on a computer/server over a network remote from the store 160 or in database 142.

The communication module 411 is configured to communicate data between the systems (e.g., tampering detection system 170, database 140, POS devices 102, etc.) herein. For example, the communication module 411 is configured to connect the tampering detection system 170 with the PS systems 102 via the network 110 using network protocols to transmit data instructed by the processor 404.

The tampering determination module 408 is configured to execute the steps of FIG. 5 to determine if a tampering is in process or may be a high probability of occurrence in the future. The tampering determination module 408 processes the data received by the cameras 136 (and readers 138) and comparing such data with the predefined tampering movements 412 and/or other triggers 412 to determine if a tampering is or has occurred.

The tampering determination module 408 may be called by the processor 404 to execute one or more functions detailed in FIG. 5.

The predefined tampering movements 412 are movements of a customer that are likely to be identified with altering the product or an SKU on the product, as described earlier herein. These predefined tampering movements 412 may be known movements and could be updated using a learning model based on historical and current on-going data. Examples of such movement have been described herein above.

The predefined triggers 412 has also been described as examples herein above as events which likely will trigger the tampering detection system 170 to identify a tampering action. For example, the triggers 412 relate to tampering with the item to remove or deactivate its UPC tag, the item’s RFID tag, remove packing, or any other action that immediately and clearly indicates tampering.

In this regard, the tampering determination module 408 uses the image and sensor/tag data along with the predefined tampering movements 412 and/or predefined triggers 412 to determine if a tampering is occurring.

The predefined tampering movements 412 and/or predefined tampering triggers 412 are continually updated and may be done so on an ongoing basis using AI technology and/or learning models.

If the tampering determination module 408 identifies a tampering is happening, it will transmit notifications and alerts to the store employees through audible, visual or other types of alerts. Additionally, the tampering determination module 408 can notify the customer 114 directly so that the customer 114 can make an immediate decision and put the item 118 back or decide to pay for the item 118. In this regard, the customer 114 is not embarrassed in public or in front of store employees and there would be no damage to property or loss to store.

Because the system identifies the potential tampering by the customer well before the customer reaches the checkout area, the system does not create a scene or drama at the store and is seamless to the customers, creating a better customer experience.

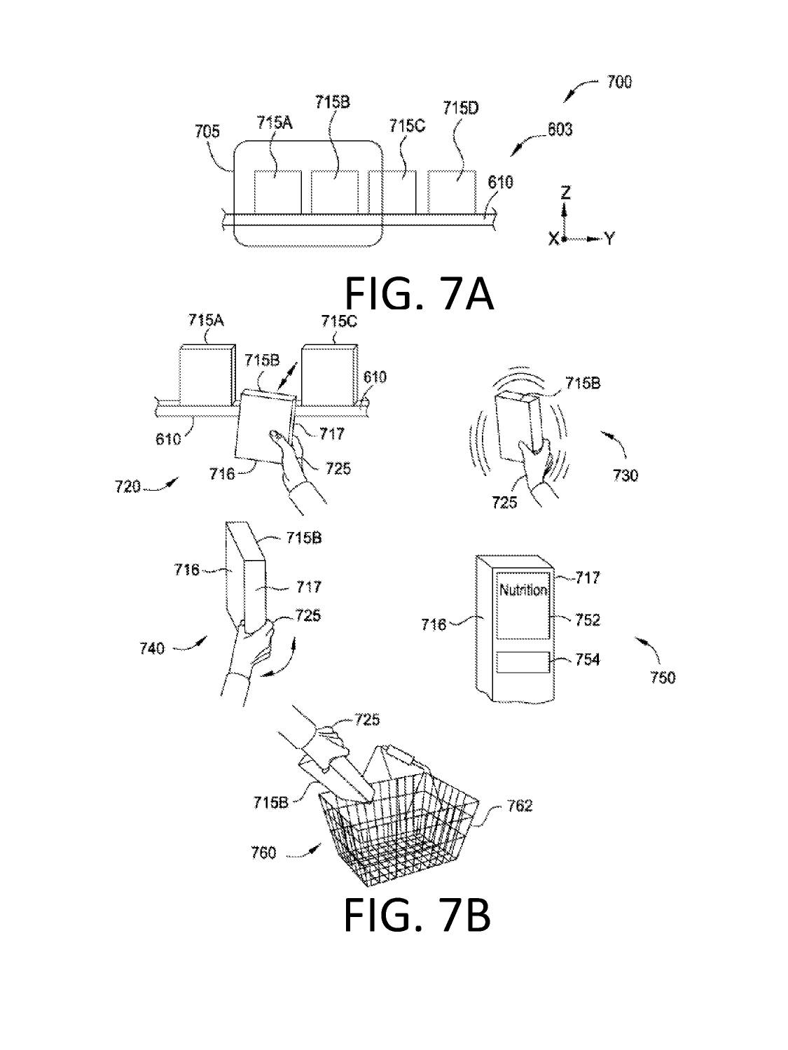

In order to detect tampering of an object, the system should determine the field of view of the customer, determine what the customer is looking at, as well as determine the behavior types of the customer. These are discussed more below with regard to FIGS. 6 and 7.

First, FIGS. 6A-6C illustrate determining field of view information for a person and identifying items included within a determined field of view, according to one embodiment. In scene 600, a shelving unit 603 is depicted having a plurality of shelves 610 that each support and display a number of items 612 that are available for selection and purchase by a person or customer.

Within the scene 600 are defined a customer's field of view 615 and an area 605 outside the customer field of view. In one embodiment, the customer's field of view 615 may be represented by an image captured from a forward-looking camera. While shown as generally rectangular, the customer field of view 615 may have any suitable alternative shape and size. For example, the customer's actual vision may encompass a significantly larger area, but determining the field of view for purposes of the shopping environment may include applying a threshold or weighting scheme that emphasizes areas that are closer to the center of a customer's vision. Of course, data provided by various visual sensors and/or other sensors within the environment may be used to make these determinations.

The field of view 615 may include a plurality of fully included items 620, as well as a plurality of partially included items 625. When determining which items to identify as “included” in the field of view, certain embodiments may categorically include or exclude the partially included items 625. An alternative embodiment may rely on image processing to determine whether a partially included item 625 should be identified as included. For example, if the processing cannot recognize the particular item with a certain degree of confidence, the item may be excluded. In another alternative embodiment, partially included items 625 may be included, and the amount of item inclusion (e.g., the percentage of surface area of the item included) may be used to determine a customer focus or calculate a customer interest score, which are discussed further below.

Items within the customer field of view 615 may be recognized by performing image processing techniques on images captured by various visual sensors. For example, images that include the items may be compared against stock item images stored in a database or server. To aid image processing, items may also include markers or distinctive symbols, some of which may include encoded item identification data such as barcodes or quick response (QR) codes. Of course, other processing techniques may be employed to recognize a particular item, such as textual recognition, determining the item's similarity to adjacent items, and so forth.

Scene 650 of FIG. 6B depicts a customer 660 in a shopping environment. The customer 660 is standing in an aisle 655 adjacent to a shelving unit 603, which has a plurality of shelves 610. Cameras may capture one or more images of scene 650 from various spatial perspectives, and the images may be used to determine the customer's field of view. Specifically, various aspects of the scene that are captured in the images may be used to estimate the customer's field of view.

In one embodiment, the relative position and/or orientation of portions of the customer's body may be determined. In one embodiment, the position and orientation of the customer's eyes 680 may be determined. For example, eye position within the environment may be determined in Cartesian coordinates (i.e., determining x, y, and z-direction values) and eye orientation may be represented by an angle α defined relative to a reference direction or plane (such as horizontal or an x-y plane corresponding to a particular value of z). In other embodiments, other portions of the customer's body may (also) be used to determine the field of view, such as the position and orientation of the customer's head 665, or of one or both shoulders 670. In other embodiments, the customer's interaction with the shelving unit 603 by extending her arm 675 may also be captured in one or more images, and the direction of the extended arm may be used to determine her field of view.

Of course, some embodiments may use combinations of various aspects of the scene to determine the customer's field of view. In some embodiments, the combinations may be weighted; for example, data showing a customer 660 reaching out her arm 675 towards a specific item may be weighted more heavily to determine her field of view than the orientation of her shoulders. In some embodiments, the weights may be dynamically updated based on the customer's shopping behaviors following an estimate of the customer's field of view. For example, if a customer reached for (or selected) an item that was not included in the determined field of view, the system may adjust the relative weighting in order to accurately capture the customer's field of view. This adjustment may include determining correlation values between particular captured aspects of the scene to the selected item; for example, the customer's head may be partly turned towards the selected item, but their eye orientation may generally be more closely tied to the selected item. In some embodiments, the correlation values may be more useful where one or more aspects of the scene cannot be determined (e.g., the system may be unable to determine eye orientation for a customer wearing sunglasses, non-optimal visual sensor positioning, etc.).

Scene 685 of FIG. 6C illustrates an overhead view of several customers 660 in a shopping environment. In one embodiment, the view of scene 685 may be represented by an image captured from a ceiling-mounted camera, or from a aerial drone.

Certain additional aspects depicted in scene 685 and captured in images may be used to estimate a customer's field of view. In one example, the orientation of customer 660A may be estimated using the relative position of his/her shoulders 670. As shown, a line connecting the two shoulders may be compared to a reference direction or plane (e.g., parallel to the length of shelving unit 603A) and represented by an angle β. In another example, the orientation of customer 660B may be estimated using the orientation of his/her head 665, comparing a direction of the customer's head to a reference direction or plane, which may be represented by an angle γ. Images may also capture a customer 660C interacting with the shelving unit 603B, and the position and/or orientation of the customer's arm 675 may be used to determine the customer's field of view.

FIGS. 7A and 7B illustrate views of several exemplary predefined behavior types, according to one embodiment. While the computing systems may determine information such as behavior information 430 and/or interest scores 460 based on all of the items identified within a determined field of view, in some embodiments it may be advantageous to make a further identification of one or more items that the person or customer is specifically focused on. Relating information more closely to person-focused items may generally improve the accuracy of assessing a person's interest in certain items, and ultimately providing more relevant and therefore more persuasive information to influence the customer's shopping experience. In one embodiment, a person's focus on certain items within a field of view may be included as one of the predefined behavior types 455, and may influence the interest scores 460 for those person-focused items.

In scene 700 depicted in FIG. 7A, items 715A-D are included on a shelf 610 of a shelving unit 603. The determined field of view 705 of a customer may include different groups of items at different times, and the progression of the customer's field of view over time may help determine which item(s) within the field of view are specifically being focused on by the customer. Generally, the customer's focus on a particular item may indicate that the item is merely attracting the customer's attention, or that the customer is deciding whether or not to purchase the item. Either way, understanding the object of a customer's focus may help retailers or suppliers to improve packaging and placement of items or to influence the customer's shopping experience in real-time.

The determined field of view 705 includes items 715A, 715B, and a portion of 715C. In one embodiment, items 715A and 715B may be included in a customer focus determination due to the items' full inclusion within the field of view 705. Conversely, item 715C may be excluded from a customer focus for being only partially included in the field of view 705. In an alternative embodiment, all three items may be included by virtue of being at least partially included in the field of view 705. In some embodiments, a customer focus on particular items may be a time-based determination. For example, if the customer's field of view 705 remained relatively steady during a preset amount of time (e.g., 5 or 10 seconds), such that both items 715A, 715B remained within the field of view during this time, the computing system may determine that the customer is focused on items 715A, 715B. In some embodiments, the particular item(s) must continuously remain in the field of view 705 during the preset amount of time (e.g., remain across several samples of the field of view during this time).

In some embodiments, the length of time that items are included in the field of view 705 may affect the classification of the behavior type, and/or may affect a numerical value related to the classified behavior type. For example, a first example predetermined behavior type may be “Viewed item between 0-5 seconds” and a second example type may be “Viewed item more than 5 seconds.” Of course, the determined length of time will be used to classify the person's behavior into one of the example behavior types. However, one or more values may also be associated with the behavior type, such as the amount of time. In this case, a person viewing an item for 8 seconds, while classified under the second example behavior type, may correspond with a larger value for the behavior type than if the person viewed the item for only 6 seconds. The classified behavior type, as well as the associated value may be used when determining the person's interest in the item. For example, viewing the item for 8 seconds may result in a larger tampering interest score for the item than viewing the item for 6 seconds.

FIG. 7B illustrates several other example behaviors, which may be included as classes of predefined behavior types. Scene 720 illustrates a person using their hand 725 to remove an item 715B from a shelf 610 and studying the item, which may increase the likelihood of tampering, as opposed to merely selecting the item and leaving the area as might be commonly performed for selecting an item for purchase. The item 715B may include a number of distinct portions, such as a front portion 716 and a side portion 717, whose relative orientation may be used to determine a person's manipulation of the item (e.g., using visual sensors). While removing the item from the shelf indicates normal movement for selecting the item, other behaviors, such as manipulation of the item greater than a predefined time threshold increases the score and thus, the likelihood of tampering. Another example behavior may be returning the item 715B to the shelf 610 and removing the item multiple times, which may is abnormal movements for the item. Of course, the associations of different behaviors with increases or decreases of tampering are merely generalities, and could very well differ in individual cases.

Another example tampering behavior is depicted in scene 730, which illustrates a person shaking the item 715B using their hand 725. The example behavior depicted in scene 740 is the rotation of the item 715B. While rotation from a view of predominantly the front portion 716 to the side portion 717 is shown, other spatial manipulations are possible. Rotation of the item may generally tend to lead to tampering of the item. Of course, a subsequent rotation back to a previous orientation may generally indicate a decrease tampering risk; a repeated back-and-forth rotation, however, may generally indicate increased tampering risk.

Scene 750 depicts a reading of the item, such as label portions 752 (i.e., nutrition information), 754 located on the side portion 717. Reading the label portions may generally indicate normal movements of the item.

Scene 760 depicts placing the item 715B into a shopping basket 762 or other receptacle (such as a shopping cart), which tends to show normal interest in the item as the person has selected the item and is more likely to complete the purchase of the item.

Referring now to FIG. 5, there is provided a flow diagram of an exemplary method 500 for providing store intelligence/detection on product tampering. The method 500 may be implemented in system 100 and concerns detecting and remedying detecting of an article (e.g., article 118 of FIG. 1) placed in a location within a facility (e.g., RSF 160 of FIG. 1) where a person has access thereto (e.g., on a shelf or other display equipment).

The method 500 begins with block 502 where data from one or more cameras is received indicating that the person picks up the article in the store. In some embodiments, only the cameras within view of the article record image data.

The imaging data captures video which indicates tampering movements and actions of the user, such as the user disassembling the item, removing packaging of the item, concealing the item, the user’s suspicious actions with the item, or the like, as discussed above.

In any event, the image data is transmitted to and received by the tampering detection system 170 for processing, as provided. It should be noted that more than one camera can be imaging the area of the tag and transmitting image data for processing of the person’s movements/actions.

A unique identifier of the item identified from images of the camera 136 are communicated to the tampering detection system 170 along with the images. The items unique identifier and camera’s images are sent along with other information, such as the current location of the person or item.

At the tampering detection system 170, the image data are processed in step 504 to determine if the user has tampered with item using analytic based operations, as discussed above.

Next at decision block 510, the tampering detection system 170 determines if there is abnormal behavior of the item or the person’s movement indicating tampering of the item. Indeed, as discussed above, the tampering detection system 170 determines if the item has been moved, disassembled, concealed, altered, or if movements of the user are abnormal including picking up and placing the item back on the shelf repeatedly, staying and studying the item for greater than a predetermined time period, if the orientation of the item is abnormal for a predefined time period, a pattern of the persons movement over a given period of time matches historical or predefined movement associated with tampering, and the like to indicate suspicious or tampering behavior. In some embodiments, the extent of abnormal behavior may include watching arm movements of the person possessing the item 118. For example, the person placing the item in a concealed fashion, such as in their purse, in their jacket, in their bookbag, or the like instead of putting the item into the cart. Pre-stored threshold values and/or image patterns can be employed in comparison operations to distinguish between normal movements/actions and abnormal movements/actions.

If the user’s movement/actions are determined to be normal and thus not tampering, then the tampering detection system 170 continues blocks 502 and 504 to continue monitoring for future tampering movements/actions.

On the other hand, if the user’s movement/actions are determined to be abnormal and thus likely tampering activities, then the method continues to block 508 where the item is flagged as a tampered item (and the user is flagged as a tampering person). Additionally, other actions may be also performed, such as: (1) cause an image to be captured of the person having possession of the article, (2) inform store personnel of the abnormal movement but transmitting an electronic message, outputting a specific sound on a speaker system, generating a visual alert, and the like, and/or (3) dispatch the store personnel to the area of the facility at which the person resides. After block 508, method 500 may continue to block 510.

In block 510, the item is determined to have been presented to the POS 102. For example, the tampered item is being scanned at the POS 102 in an attempt for a person to buy the tampered item. If any customer takes a flagged item to a POS 102 (block 514), the POS 102 communicates with the tampering detection system 170 in order to query the database to determine if the item is flagged. To do this, in block 516, the item will then will be compared to an e-Commerce image of the item to determine if the item is as expected (i.e., whether or not the item has all of the components, whether the item looks like the item in the SKU, etc.); otherwise, the method will continue to loop from block 516 to 514 until the item is presented to the POS or the tampering is remedied (i.e., all components of the item are restored, the correct SKU is applied to the item, etc.). The e-Commerce image may be obtained from database 140 or from another source and illustrates an image (3-D image) of the product and compare that image to the scanned item.

If the item matches the e-Commerce image in determination block 516, the method 500 continues to block 520 where item is allowed to be purchased (because the item was not actually tampered or the tampered item was restored back to it’s original condition); otherwise, if the item does not match the e-Commerce image in determination block 516, the method 500 continues to block 518 where the item is blocked from being purchased and store personnel are alerted of the tampered product.

It should be understood that the method 500 could be constantly updated and data could be used to train the model. For example, in some embodiments, the movements of the person may be compared with predetermined tampering movements stored in the database. If an item is determined to have been tampered with, the movements of that person who tampered with the item can be analyzed and saved as additional predetermined tampering movements/actions for future use so that future movements/actions of people in the store that match such predetermined tampering movements/actions will trigger the tampering detection alarm. For example, if a person had stood at a shelf and grabbed an item and looked around to see if anyone was watching for 30 seconds, and then eventually tampered with the item, a future person making the same movements will trigger such a tamper detection.

Moreover, an artificial intelligence (AI) model can be fed the predetermined tampering movements/actions and learn these behaviors so that it is constantly being updated. As such, the predetermined tampering movements/actions are constantly being modified and understood based on changing behaviors and new behaviors as the thieves change their behaviors to try to outsmart the systems in the stores. In this regard, the predetermined tampering movements/actions are updated using AI learning models. Similarly, the AI learning models update the predefined triggers as well based on previous actions determined by the models to be tampering movements/actions.

Moreover, the AI models can be updated using other data from other stores. The AI models would compare the data for known tampering movements/actions from both the security camera footage and the in store movement that is identified through the RFID tracking and update the models and data accordingly and immediately apply those new models to current algorithms in the stores to determine if tampering movements/actions has occurred while in the shopping area of the stores.

It should be understood that the AI models would identify the common behavior patterns of the users prior to entering the store and while moving through the store. And when a behavior pattern is identified in real time, the store security personnel could be alerted via a mobile device.

Thus, the idea herein is to look at the pattern of movement within the shopping area 105 of the store before the person gets to the POS and then stop the item from being purchased store. Indeed, as described above, the first step would be to learn the patterns of normal shoppers who are going to head to the checkout to purchase the product versus shoppers who will try to tamper with items. Once pattern(s) of movement are identified that are likely to result in product tampering, those patterns can be flagged and alerted to the security personnel who could handle it before they even get to the front of the store or stop the product at checkout.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof, means any connection or coupling, either direct or indirect, between two or more elements; the coupling of connection between the elements can be physical, logical, or a combination thereof. Additionally, the words "herein," "above," "below," and words of similar import, when used in this application, shall refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above detailed description of embodiments of the present disclosure is not intended to be exhaustive or to limit the present disclosure to the precise form disclosed above. While specific embodiments of, and examples for, the present disclosure are described above for illustrative purposes, various equivalent modifications are possible within the scope of the present disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the present disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the present disclosure can be modified, if necessary, to employ the systems, functions, and concepts of the various references described above to provide yet further embodiments of the present disclosure.

These and other changes can be made to the present disclosure in light of the above Detailed Description. While the above description describes certain embodiments of the present disclosure, and describes the best mode contemplated, no matter how detailed the above appears in text, the present disclosure can be practiced in many ways. Details of the system may vary considerably in its implementation details, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific embodiments disclosed in the specification, unless the above Detailed Description section explicitly defines such terms. Accordingly, the actual scope of the present disclosure encompasses not only the disclosed embodiments, but also all equivalent ways of practicing or implementing the present disclosure under the claims.

While certain aspects of the present disclosure are presented below in certain claim forms, the inventors contemplate the various aspects of the present disclosure in any number of claim forms. For example, while only one aspect of the present disclosure may be recited as a means-plus-function claim under 35 U.S.C sec. 112(f), other aspects may likewise be embodied as a means-plus-function claim, or in other forms, such as being embodied in a computer-readable medium. (Any claims intended to be treated under 35 U.S.C.§112(f) will begin with the words "means for".) Accordingly, the inventors reserve the right to add additional claims after filing the application to pursue such additional claim forms for other aspects of the present disclosure.

What is claimed is:

1. A method comprising:
receiving, from at least one camera, imaging data of a person tampering with an object for sale in a shopping area of a store;
determining, using the imaging data taken by the at least one camera, that a tampering event is occurring or has occurred before the object has been presented to be purchased;
flagging the object as a tampered object so that remediating steps can be taken to prevent the tampered object from being sold.

2. The method according to claim 1, further comprising:
retrieving an e-Commerce image of the object;
comparing the e-Commerce image to an image of the object being presented at checkout, wherein the e-Commerce image comprises an image of the object prior to being tampered with; and
determining that the object has been tampered with in response to determining that the e-Commerce image does not match the image of the object.

3. The method according to claim 2, further comprising:
scanning the object at a point of sale device for checkout;
identifying an identifier of the object;
querying a database with the identifier to determine the e-Commerce image of the object to retrieve; and
receiving from an imaging device the image of the object being presented at checkout.

4. The method of claim 1, further comprising:
tracking a location of the in store in response to the object being flagged.

5. The method of claim 1, wherein the flagging of the object comprises indicating in a database that the object has been tampered with.

6. The method according to claim 1, further comprising checking at a checkout area if the object has been tampered with.

7. The method according to claim 6, wherein the determining, using the imaging data taken by the at least one camera, that the tampering event is occurring or has occurred is based on historical movement/actions data and/or predefined movement/actions.

8. The method according to claim 7, wherein the determining, using the imaging data taken by the at least one camera, that the tampering event is occurring or has occurred comprises:
determining, based on historical movement/actions data and/or predefined movement/actions, whether movement or actions of the user comprises analyzing the imaging data to determine one of the follow from the group of is occurring or has occurred: removing a UPC code of the object, removing a portion of the object from the object, removing packaging of the object, holding the object greater than a predefined threshold.

9. The method according to claim 8, further comprising using a learning model to constantly update the movement/actions data.

10. A system comprising:
a camera directed to an object in a shopping area of a store;
a processor configured for:
receiving, from at least one camera, imaging data of a person tampering with an object for sale in a shopping area of a store;
determining, using the imaging data taken by the at least one camera, that a tampering event is occurring or has occurred before the object has been presented to be purchased;
flagging the object as a tampered object so that remediating steps can be taken to prevent the tampered object from being sold.

11. The system according to claim 10, wherein the processor is further configured for:
retrieving an e-Commerce image of the object;
comparing the e-Commerce image to an image of the object being presented at checkout, wherein the e-Commerce image comprises an image of the object prior to being tampered with; and
determining that the object has been tampered with in response to determining that the e-Commerce image does not match the image of the object.

12. The system according to claim 11, wherein the processor is further configured for:
scanning the object at a point of sale device for checkout;
identifying an identifier of the object;
querying a database with the identifier to determine the e-Commerce image of the object to retrieve; and
receiving from an imaging device the image of the object being presented at checkout.

13. The system according to claim 10, wherein the processor is further configured for:
tracking a location of the in store in response to the object being flagged.

14. The system according to claim 10, wherein the flagging of the object comprises indicating in a database that the object has been tampered with.

15. The system according to claim 10, wherein the processor is further configured for checking at a checkout area if the object has been tampered with.

16. The system according to claim 15, wherein the determining, using the imaging data taken by the at least one camera, that the tampering event is occurring or has occurred is based on historical movement/actions data and/or predefined movement/actions.

17. The system according to claim 10, wherein the processor is further configured for:
analyzing, by the electronic device, the tag data and image data to determine if the security tag is located in or traveling towards a high risk location of a facility; and
selectively performing, by the electronic device, fourth operations facilitating facility security if a determination is made that the security tag is located in or traveling towards a high-risk location of a facility.

18. The system according to claim 1, wherein the processor is further configured for using a learning model to constantly update predefined tag triggers and predetermined theft movements.

19. A nontransitory computer readable medium that, when executed by a processor, performs a method comprising:
receiving, from at least one camera, imaging data of a person tampering with an object for sale in a shopping area of a store;
determining, using the imaging data taken by the at least one camera, that a tampering event is occurring or has occurred before the object has been presented to be purchased;
flagging the object as a tampered object so that remediating steps can be taken to prevent the tampered object from being sold.

20. The nontransitory computer readable medium according to claim 19, wherein the method further comprising:
retrieving an e-Commerce image of the object;
comparing the e-Commerce image to an image of the object being presented at checkout, wherein the e-Commerce image comprises an image of the object prior to being tampered with; and
determining that the object has been tampered with in response to determining that the e-Commerce image does not match the image of the object.
